(19) United States
(12) Patent Application Publication
(10) Pub. No.: US 2025/0217789 A1
(43) Pub. Date: Jul. 3, 2025

(54) ADAPTIVE NETWORK ROUTING PROTOCOLS

(71) Applicant: Bank of America Corporation, Charlotte, NC (US)

(72) Inventors: Sandeep Verma, Gurugram (IN); Sneha Padiyar, Mumbai Maharashtra (IN); Beena Rao, Mumbai Maharashtra (IN); Amruta Kiran Minche, Virar Maharashtra (IN)

(21) Appl. No.: 18/401,782

(22) Filed: Jan. 2, 2024

(51) Int. Cl. G06Q 20/32; G06Q 20/38; H04L 9/40

(52) U.S. Cl. CPC G06Q 20/325; G06Q 20/3829; H04L 63/0435

(57) ABSTRACT

Systems, methods, and apparatus are provided for adaptive network routing protocols. A mobile device application may receive a request to pair a first payment instrument with a second payment instrument. The application may generate a preauthorized routing packet encoding information associated with the first payment instrument. The routing packet may be QR code encrypted using a private key associated with the network and functioning as a digital wallet. The routing packet may be deployed to a processing network associated with the second payment instrument. The processing network may receive transaction information from a point of sale, including a charge initiated using the second payment instrument. The processing network may access the routing packet and determine whether transaction routing is active. When transaction routing is active, the charge may be routed to the first payment instrument. When transaction routing is not active, the second payment instrument may be charged.

### FIELD OF TECHNOLOGY

Aspects of the disclosure relate to adaptive routing protocols for an electronic network.

### BACKGROUND OF THE DISCLOSURE

An individual may present a payment method at a point of sale to execute a transaction. In many scenarios, it would be useful for the charge at the point of sale to be rerouted to an alternate payment method in place of the one presented to the merchant.

In one illustrative scenario, a first party may not be able to be physically present at a point of sale. It would be desirable for a second party to initiate the transaction but have the charge routed to a payment instrument associated with the first party.

In another illustrative scenario, a first party may wish to assist a second party by covering a payment. It would be desirable for the second party to initiate the transaction but have the charge routed to a payment instrument associated with the first party.

In another illustrative scenario, a first party may assist a second party in a case where their transaction is denied for exceeding a payment limit or the payment card is non-responsive. It would be desirable for the second party, following a failed transaction, to route the charge to a payment instrument associated with the first party.

It would be desirable to protect the security of both parties by shielding the details of the first party payment instrument from the second party and shielding the details of the second party payment instrument from the first party.

It would be desirable to enable controls for initiating and terminating the transaction rerouting in real time and to implement limits on timing and payment amount for routing charges between payment instruments.

### SUMMARY OF THE DISCLOSURE

Systems, methods, and apparatus are provided for adaptive network routing protocols.

A mobile device application may receive a request to pair a first payment instrument with a second payment instrument.

The mobile device application may generate a preauthorized routing packet encoding payment instrument information associated with the second payment instrument. The application may deploy the routing packet to a processing network associated with the second payment instrument.

The processing network associated with the second payment instrument may receive transaction information from a point of sale. The transaction information may include a charge initiated using the second payment instrument. The processing network may access the routing packet and determine whether transaction routing is active. When transaction routing is active, the charge may be routed to the first payment instrument. When transaction routing is not active, the second payment instrument may be charged.

The claims recite a practical application including backend network adaptations that enable a first party to remotely charge a payment card that is not used at a point of sale. A preauthorized routing packet may be deployed to a carrier network associated with a second party card and may encode rerouting parameters including time and credit limits selected by the first party. The second party may initiate the charge with their own payment card without access to the first party payment card or any of the first party card information. These adaptive rerouting protocols expand network capabilities while improving security.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows an illustrative process flow in accordance with principles of the disclosure;

FIG. 4 shows an illustrative process flow in accordance with principles of the disclosure; and

FIG. 5 shows an illustrative process flow in accordance with the principles of the disclosure.

### DETAILED DESCRIPTION

Systems, methods, and apparatus are provided for adaptive network routing protocols.

In many scenarios a party may wish to execute a transaction remotely, without being present at a point of sale. In one illustrative example, the party may not be physically able to be present. In another illustrative example, the point of sale may be a digital portal and the party may not know how to navigate the interface.

Conventionally, a first party might provide a second party with their payment instrument to execute the transaction on their behalf. However, providing sensitive account information to an outsider, even a family member, may risk compromise. It would be desirable to enable a second party to initiate a transaction at a point of sale on behalf of the first party without providing the second party with access to any sensitive information.

For the sake of illustration, the invention will be described as being performed by a “system.” The system may include one or more features of apparatus and methods that are described herein and/or any other suitable device or approach.

The system may include a payment instrument. Illustrative payment instruments may include a credit card, a debit card, a stored value card such as a gift card, or any suitable payment instrument. The payment instrument may be a digital or virtual instrument. The payment instrument may be a mobile device such as a smartphone, tablet, wearable device, or other mobile terminal. The payment instrument may be issued by an issuer financial institution.

The system may include a mobile banking application. The mobile banking application may be associated with an issuer financial institution.

The system may enable a first party to register a pairing with a second party payment instrument. Registration may be implemented at the mobile banking application, at a secure internet portal, at a self-service kiosk such as an automated teller machine (ATM), by telephone, or in any other suitable manner.

During registration at a mobile banking application, the first party may access the mobile banking application. The first party may select an option to pair a second party payment instrument for transaction routing. The mobile banking application may scan the second party payment instrument using a mobile device camera or by any suitable method. In some embodiments, the first party may manually enter second party payment instrument information. In some embodiments, the second party payment instrument information may be retrieved from a digital wallet or from any suitable electronic storage medium.

The second party payment instrument may be associated with the same financial institution as the mobile device application. The second party payment instrument may be associated with a different financial institution. The second party payment instrument may be associated with the same issuer as a first party payment instrument. The second party payment instrument may be associated with a different issuer. The second party payment instrument may be associated with the same transaction processing network as the first party payment instrument. The second party payment instrument may be associated with a different transaction processing network.

The mobile banking application may transmit an authorization request to the second party. The second party may authorize the pairing. The mobile banking application may securely store information associated with the second party payment instrument. In some embodiments, the pairing information may be stored in a secure database associated with the financial institution.

The system may enable the first party to initiate transaction routing. The first party may access the mobile banking application to initiate transaction routing. The first party may select an option for transaction routing. The mobile banking application may display second party payment instruments, such as cards that have been registered for pairing. Sensitive information associated with a paired second party card, such as the card number, expiration date, and/or card verification value, may be masked to prevent viewing by the first party. The first party may select a paired card from the display.

The first party may identify a first party instrument for transaction routing. The first party may select a payment card, bank account, or other payment option from within the mobile banking application.

Alternatively, the first party may initiate routing to a payment card that is not accessible within the mobile banking application, such as a card from a different issuer. The mobile device application may access a device camera. The mobile device application may use the camera to capture an image of the first party payment card. In some embodiments, the mobile device camera may be opened automatically in response to selection of an option for transaction routing from within the mobile application.

The mobile device application may extract payment instrument data from the image, Payment instrument data may include an account number, a card number, a card expiration date, a name, a card verification value, an expiration date, an issuer, a transaction processing network, or any suitable payment instrument data.

The first party may initiate routing to a prepaid quick response (QR) code. The prepaid QR code may have been generated from a first party account. The prepaid QR code may be charged for the transaction following the transaction routing. The mobile device camera may capture the QR code and extract the payment information.

The mobile banking application may include selectable options associated with a paired card. Illustrative selectable options may include “start routing,” “modify routing,” “view transactions,” and “remove card.”

The first party may select an option to initiate routing. The mobile banking application may display one or more routing configuration fields. The fields may include a credit limit. The fields may include a time limit. The first party may enter a credit limit and/or a time limit for the transaction routing. In some embodiments, the first party may enter times for the routing to start and finish. In some embodiments, the display may include a default time limit and a default credit limit. The first party may modify the default limits.

The mobile banking application may generate a preauthorized transaction routing packet. The transaction routing packet may be deployed to a payment processing network such as Visa® or Mastercard®. The processing network may be a processing network associated with the second payment card.

The transaction routing packet may include a QR code. The QR code may be encrypted using a private key associated with the network. The key may be proprietary to a financial institution that is associated with the mobile application. The financial institution and the transaction processing network may have an existing channel and the mobile application may use a private key associated with this channel for the encryption.

The QR code may encode data associated with the second party payment instrument. The QR code may encode transaction limits associated with the routing such as a time limit and/or credit limit.

The transaction processing network may receive the QR code. The transaction processing network may parse the routing details and start or stop the transaction routing.

At a point of sale, the second party may initiate a transaction using the second party payment instrument. The point of sale may be a merchant location, a self-service kiosk, a web-based portal, or any other suitable point of sale. A point-of-sale terminal may transmit transaction information to transaction processing network.

Illustrative transaction information may include transaction instrument identifiers such as a card number, media access control address or IP address, transaction instrument issuer identifiers such as a bank issuer number (BIN), financial institution account information, financial institution routing information, transaction processing network identifiers, transaction amount, transaction date and/or time, merchant identifiers, EFT information, ACH information, or any suitable information.

The transaction processing network may determine whether routing is active on the second party payment instrument. If transaction routing is active, the QR code may act as a preapproved virtual wallet. If the timing and transaction amount are within the approved limits, the network may route the charge to the issuer of the first party payment instrument for authorization. The mobile application may inform the first party of the charge.

If transaction routing is not active, or if the timing and transaction amount are not within the preapproved limits, the transaction network may route the charge to the issuer of the second payment instrument. In some embodiments, if the timing and transaction amount are not within the preapproved limits, the transaction may be aborted.

In some embodiments, the transaction routing may be implemented by a single user. The user may pair a first payment instrument with a second payment instrument. Both payment instruments may be associated with the same user. In the event of a failed transaction using the first payment instrument, the user may choose to reroute the charge to the second payment instrument, even if the second payment instrument is not with them at the point of sale.

One or more non-transitory computer-readable media storing computer-executable instructions are provided. When executed by a processor on a computer system, the instructions perform a method for adapting network protocols for rerouting a point-of-sale electronic transaction.

A second party may initiate a transaction using their own payment instrument that routes the charge to their regular carrier network associated with the payment instrument. Backend modifications may enable the charge to be rerouted in real time to a first party payment instrument.

The method may include, at a mobile device application, receiving a request to pair a first payment instrument with a Second payment instrument.

The method may include generating a preauthorized routing packet encoding payment instrument information associated with the first payment instrument. The method may include transmitting the routing packet to a carrier network associated with the second payment instrument.

The method may include, at the carrier network, receiving transaction information from a point of sale. The transaction information may include a charge initiated using the second payment instrument.

The method may include, based on the routing packet, determining if transaction routing is active on the second payment instrument. The method may include, when transaction routing is active, accessing the routing packet and routing the charge to the first payment instrument and when transaction routing is not active, charging the second payment instrument.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

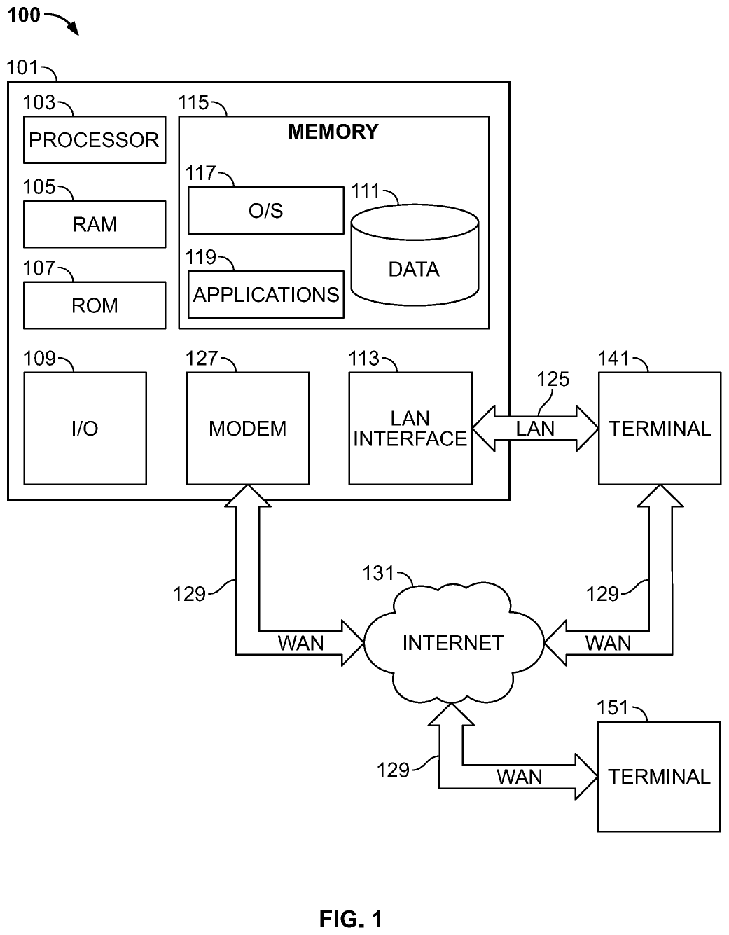

FIG. 1 shows an illustrative block diagram of system 100 that includes computer 101, Computer 101 may alternatively be referred to herein as an “engine,” “server,” “or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of System 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for electronic transaction routing as detailed herein.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCS, minicomputers, mainframe computers, distributed Computing environments that include any of the above systems or devices, and the like.

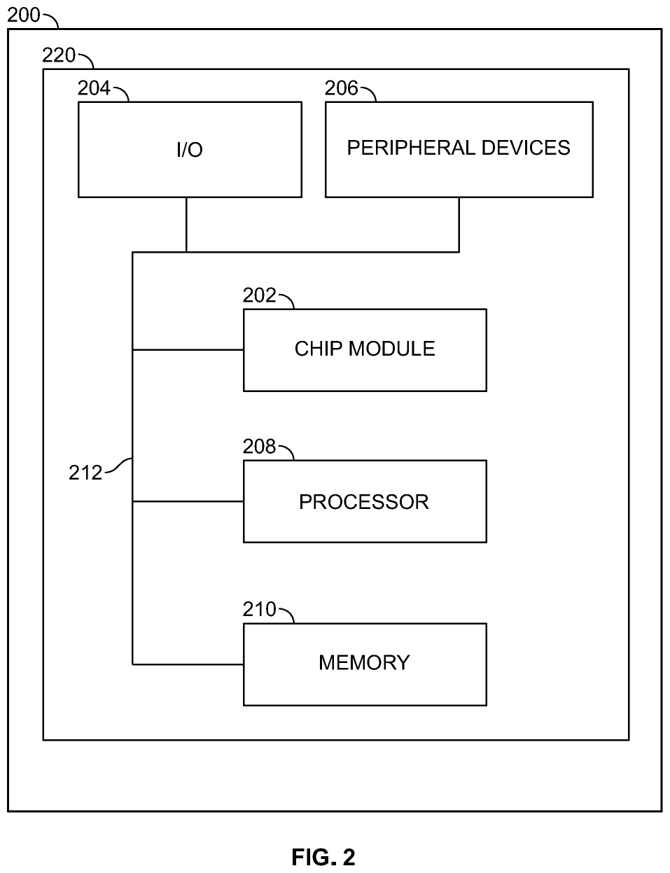

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following Components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

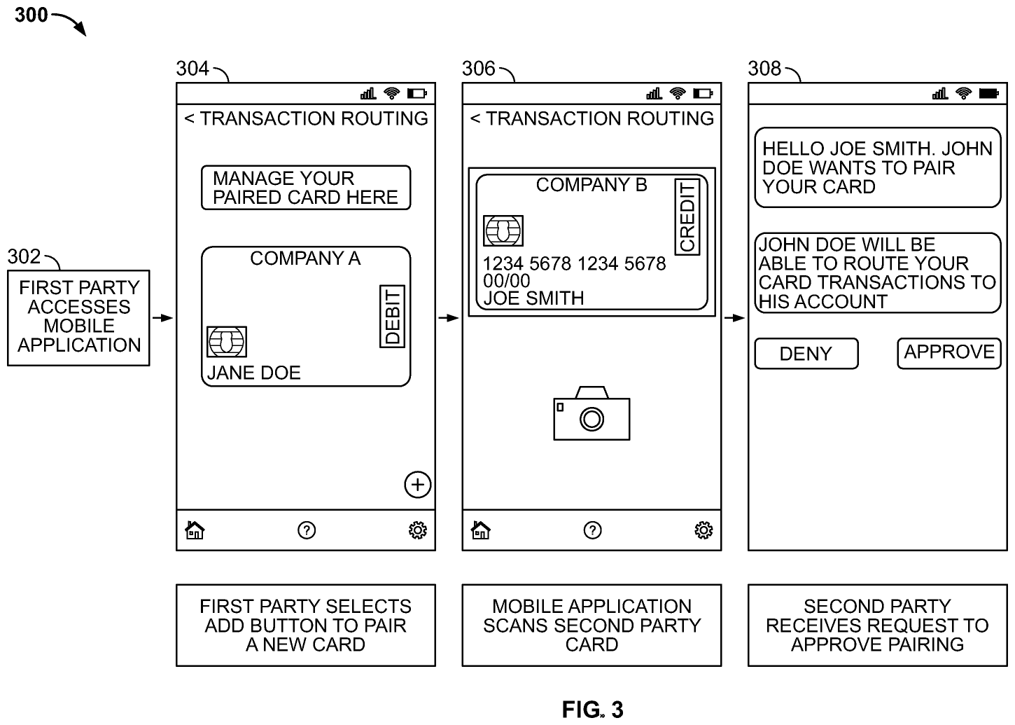

FIG. 3 shows illustrative process flow 300 for pairing payment instruments for transaction routing, At 302, a first party may log in to a mobile application and select transaction routing. At 304, a mobile device screen may display previously paired cards. The mobile device screen may include a selectable button for pairing a new card associated with a second party, At 304, the mobile device screen shows a previously paired card from “Jane Doe.”

At 306, the mobile application may access the device camera and capture an image of the new card. At 306, the new card belongs to second party “Joe Smith.” The mobile application may use optical character recognition or any suitable image recognition algorithms to extract payment information from the card image. The payment information may include a transaction network associated with the card.

At 308, the mobile application may transmit a communication to the second party. The communication may request that the second party approve the pairing. Following approval, the mobile application may store the paired card as shown at 304. The mobile application display may display the card with the name of the second party but may mask sensitive details to ensure that the first party does not have full access to the second party card.

The features of the mobile application displays shown in process flow 300 are illustrative but any suitable text or graphics may be included in the display.

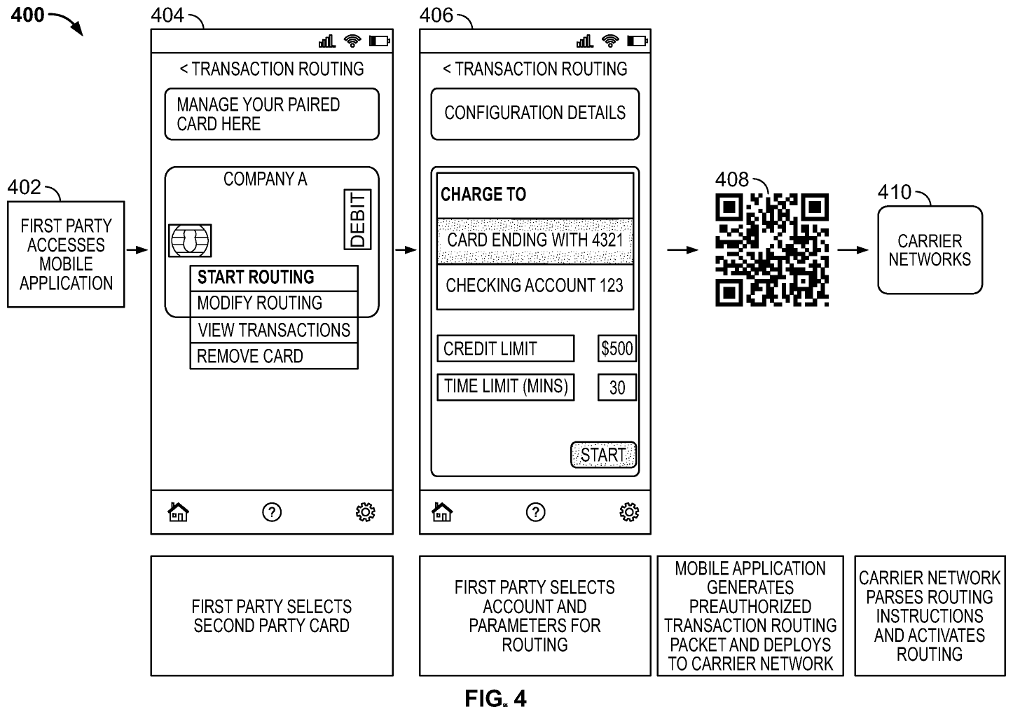

FIG. 4 shows illustrative process flow 400 for controlling the transaction routing. At 402, a first party may access a mobile application and select transaction routing.

At 404, the first party may select a paired card associated with a second party. The mobile application may display selectable options. A “start routing” option may enable the first party to set up routing for a defined time period. A “modify routing” option may enable the first party to make changes to routing that has already been initiated. A “view transactions” option may display past transactions in which charges were routed from the paired card to a first party account. A “remove card” option may enable the first party to cancel the pairing and delete the paired card. The selectable options shown are illustrative, but any suitable options may be included.

At 406, the first party may select one of their own accounts. A charge initiated by the paired card may be routed to this account. The mobile application may be associated with a financial institution. The mobile application may enable access to an account or card associated with the financial institution. The financial institution may be the card issuer. The first party may select from these accounts or cards from within the mobile application.

The first party may also select from payment methods associated with other financial institutions. The mobile application may be configured to scan a payment method such as a card or pre-paid QR code and capture the payment details for routing a charge from a paired card (not shown).

At 408, mobile application may generate a the preauthorized transaction routing packet. The routing packet may be encrypted as a QR code. The routing packet may be deployed to a transaction carrier associated with the selected paired card, such as Visa® or Mastercard®. At 410, the transaction processing network may decrypt the routing instructions to initiate or terminate routing from the second party payment instrument to the first party account.

The features of the mobile application displays shown in process flow 400 are illustrative but any suitable text or graphics may be included in the display.

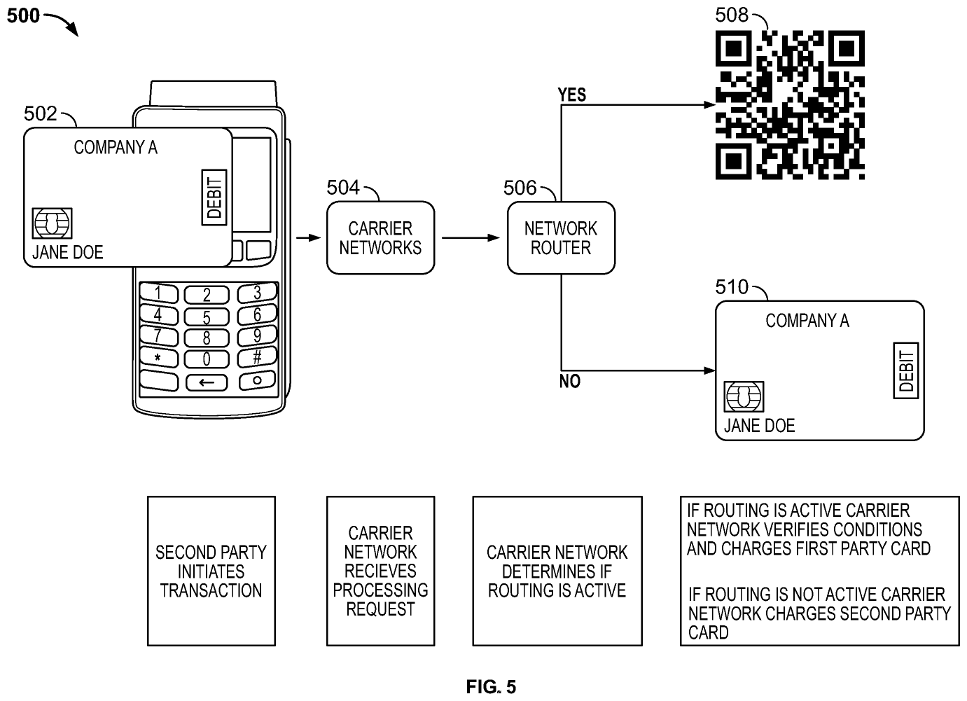

FIG. 5 shows illustrative process flow 500 for implementing transaction routing. At 502, a second party may use their payment card to initiate a transaction at a point of sale, At 504, a carrier network may receive a processing request from the point of sale.

A point-of-sale network may include a router (not shown) that routes transaction information to a carrier associated with the payment instrument presented at the point of sale. The carrier network may include router 506. Router 506 may be configured to transmit transaction information to an issuer associated with the payment instrument presented at the point of sale. Router 506 may be configured to reroute the charge to a different payment instrument.

The carrier network may determine whether rerouting is active. Rerouting may be initiated as set forth in FIG. 4. At 508, if rerouting is active, the carrier network may verify conditions in the preauthorized routing packet and reroute the charge to a first party payment instrument. The routing packet may function as a time-bound virtual wallet. At 510, if rerouting is not active, the carrier network may charge the second party card.

Thus, methods and apparatus for ADAPTIVE NETWORK ROUTING PROTOCOLS are provided. Persons skilled in the art will appreciate that the present invention can be practiced by other than the described embodiments, which are presented for purposes of illustration rather than of limitation, and that the present invention is limited only by the claims that follow,

What is claimed is:

1. A method for adapting network protocols for real-time rerouting of an electronic transaction, the method comprising:
at a mobile device application, running on a device processor:
receiving a request to pair a first payment instrument with a second payment instrument;
generating a preauthorized routing packet encoding payment instrument information associated with the first payment instrument; and
deploying the routing packet to a processing network associated with the second payment instrument; and
at the processing network;
receiving transaction information from a point of sale, the transaction information comprising a charge initiated using the second payment instrument;
accessing the routing packet and determining whether transaction routing is active on the second payment instrument;
when transaction routing is active, using a network router, routing the charge to the first payment instrument; and
when transaction routing is not active, charging the second payment instrument.

2. The method of claim 1, the method further comprising, at the mobile application, receiving approval of the pairing from a party associated with the second payment instrument.

3. The method of claim 1, further comprising encrypting the routing packet using a private key associated with a preexisting channel between an enterprise associated with the mobile device application and the processing network.

4. The method of claim 1, wherein accessing the routing packet further comprises validating a condition encoded in the routing packet against the transaction information.

5. The method of claim 1, wherein the routing packet is a QR code, the QR code functioning as a digital wallet, the processing network comprising a decryption key configured to decrypt the QR code.

6. The method of claim 5, the QR code encoding a limit associated with routing the charge initiated by the second payment instrument to the first payment instrument.

7. The method of claim 1, wherein routing the charge to the first payment instrument comprises rerouting the charge from the payment network associated with the second payment instrument to a payment network associated with the first payment instrument.

8. One or more non-transitory computer-readable media storing computer-executable instructions which, when executed by a processor on a computer system, perform a method for adapting network protocols for rerouting a point-of-sale electronic transaction, the method comprising:
at a mobile device application:
receiving a request to pair a first payment instrument with a second payment instrument;
generating a preauthorized routing packet encoding payment instrument information associated with the first payment instrument; and
transmitting the routing packet to a transaction processing network associated with the second payment instrument; and
at the transaction processing network:
receiving transaction information from a point of sale, the transaction information comprising a charge initiated using the second payment instrument;
based on the routing packet, determining if transaction routing is active on the second payment instrument;
when transaction routing is active, accessing the routing packet and routing the charge to the first payment instrument; and
when transaction routing is not active, charging the second payment instrument.

9. The media of claim 8, further comprising encrypting the routing packet using a private key associated with the mobile device application and the transaction processing network.

10. The media of claim 8, wherein accessing the routing packet further comprises validating a condition encoded in the routing packet against the transaction information.

11. The media of claim 8, wherein the routing packet is a QR code, the QR code functioning as a digital wallet.

12. The media of claim 8, the QR code encoding a limit associated with routing the charge initiated by the second payment instrument to the first payment instrument.

13. The media of claim 12, wherein the limit is a time limit.

14. The media of claim 12, wherein the limit is a credit limit.

15. A system for adapting network protocols for rerouting an electronic transaction to an alternate mode of payment, the method comprising:
a mobile device application running on a device processor and configured to;
receive a request to pair a first payment instrument with a second payment instrument;
generate a preauthorized routing packet encoding payment instrument information associated with the first payment instrument; and
deploy the routing packet to a computer processing network associated with the second payment instrument; and
the computer processing network configured to;
receive transaction information from a point of sale, the transaction information comprising a charge initiated using the second payment instrument;
access the routing packet and determining whether transaction routing is active on the second payment instrument;
when transaction routing is active, route the charge to the first payment instrument using a network router; and
when transaction routing is not active, charge the second payment instrument.

16. The system of claim 15, the mobile application configured to receive approval of the pairing from a party associated with the second payment instrument.

17. The system of claim 15, the mobile application configured to encrypt the routing packet using a private key associated with a preexisting channel between the mobile device application and the computer processing network.

18. The system of claim 15, wherein accessing the routing packet comprises validating a condition encoded in the routing packet against the transaction information.

19. The system of claim 15, wherein the routing packet is a QR code, the QR code functioning as a digital wallet.

20. The system of claim 19, the QR code encoding a limit associated with routing the charge initiated by the second payment instrument to the first payment instrument.

21. The system of claim 15, the routing packet comprising an instruction to route the charge from the processing network associated with the second payment instrument to a processing network associated with the first payment instrument.
